(19) United States
(12) Patent Application Publication
(10) Pub. No.: US 2012/0225326 A1
(43) Pub. Date: Sep. 6, 2012

(54) MODULE ELEMENT, IN PARTICULAR FOR A BIOFUEL CELL, AND MANUFACTURING PROCESS

(75) Inventors: Richard Fournel, Lumbin (FR); Aomar Halimaoui, La Terrasse (FR)

(73) Assignees: STMICROELECTRONICS (CROLLES 2) SAS, Crolles Cedex (FR); STMICROELECTRONICS S.A., Montrouge (FR)

(21) Appl. No.: 13/406,749

(22) Filed: Feb. 28, 2012

(30) Foreign Application Priority Data
Mar. 4, 2011 (FR) 1151775

(51) Int. Cl. H01M 8/16; B05D 5/12; H01M 8/00

(52) U.S. Cl. 429/2; 429/401; 429/535; 427/115

(57) ABSTRACT

A module of a biofuel cell includes three module elements each having a porous membrane. At least two of the porous membranes are electrically conducting and form the cathode and the anode of the biofuel cell. The third membrane, which is preferably positioned between the two electrically conducting membranes need not be conducting, but defines two emergent cavities within the module. A porous through-channel extends through a silicon support of the module so as to connect one of the emergent cavities to at least one external wall of the silicon support.

### PRIORITY CLAIM

This application claims priority from French Application for Patent No. 1151775 filed Mar. 4, 2011, the disclosure of which is hereby incorporated by reference.

### TECHNICAL FIELD

The invention relates to microelectronics and more particularly to module elements intended to form modules capable, for example, but not exclusively, of being used to produce biofuel cells.

### BACKGROUND

A biofuel cell is a fuel cell that uses enzymes or microorganisms, such as bacteria, to convert some of the energy available in a bio degradable substrate into electricity.

In general, a biofuel cell comprises an electrode, forming the anode, placed in contact with enzymes for converting the biodegradable substrate, for example glucose, in particular into electrons that are captured by the anode. The biofuel cell also includes a cathode at which an electron acceptor, for example oxygen (contained for example in the air), is reduced to water.

A potential difference therefore appears between the anode and the cathode.

There are many publications in the field of biofuel cells.

Mention may in particular be made of the article by Philippe Cinquin et al. entitled “A Glucose BioFuel Cell Implanted in Rats”, PLoS ONE/www.plosone.org, May 2010/volume 5/Issue 5/e10476 (the disclosure of which is incorporated by reference), which describes the production of an experimental biofuel cell implanted into a rat. This biofuel cell is capable of in vivo electricity production by virtue of the redox phenomenon mentioned above starting from oxygen and glucose in the physiological fluids of the rat. Two different powders (enzymes) are used at the anode and cathode respectively.

Reference may also be made to the article by Lewis Dartnell entitled “Sparks of Life” and available at the Internet address http://www.ucl.ac.uk/˜ucbplyd/sparks_page.htm (the disclosure of which is incorporated by reference). This article describes a biofuel cell using bacteria called Rhodoferax ferrireducens at the anode.

It is appropriate now to propose industrially acceptable solutions, in particular for reducing the size of the implants and to increase the power generated by these biofuel cells.

### SUMMARY

One embodiment provides a module element and a module that can be used, especially but not exclusively, as constituents of a biofuel cell, which can be produced on an industrial scale and are compatible with implantation into the human body.

According to one aspect, there is provided a module element comprising a silicon support having a through-orifice closed off by a porous membrane attached to the support.

According to one embodiment, said porous membrane is electrically conducting and delimits with the support at least one emergent cavity formed in said through-orifice.

Such a module element can then form a cathode or an anode of a module capable of being used, for example, as a biofuel cell.

The support may furthermore include an electrically conducting contact zone, for example a zone comprising a metal silicide, which is electrically coupled to said electrically conducting porous membrane.

Such a contact zone thus facilitates the electrical contact to the cathode and/or to the anode of the module.

The electrically conducting porous membrane may comprise a metal silicide and may for example be completely formed from metal silicide.

As a variant, depending in particular on the thickness of metal deposited, said electrically conducting porous membrane may comprise porous silicon coated with a metal silicide.

According to another embodiment, the porous membrane is not electrically conducting and it may comprise porous silicon.

Such a module element can then act as a membrane for delimiting, for example, the anode and cathode regions of the biofuel cell.

The porous membrane may delimit with the support at least one emergent cavity formed in said through-orifice.

The porous membrane may also delimit with the support two emergent cavities that are formed in said through-orifice, and located respectively on either side of said membrane.

It is also possible for the module element to further include at least one porous through-channel, for example of porous silicon, made in the support and connecting said at least one emergent cavity to at least one external wall of the support.

Whatever the embodiment, the pore size of the membrane, whether it is electrically conducting or not, is, for example, of the order of a few nanometers.

According to another aspect, there is provided a module, comprising: a first module element as defined above and provided with an electrically conducting porous membrane, a second module element as defined above, and also provided with an electrically conducting porous membrane, and a third module element as defined above and forming a membrane, this third module element being placed between the first module element and the second module element; the three module elements being attached to one another so as to form an assembly, said at least one emergent cavity of the first module element opening onto said porous membrane of the third element, i.e. the element sandwiched between the other two, said at least one emergent cavity of the second element opening onto the porous membrane of the third element, and a first active substance being housed in said at least one emergent cavity of the first element, whereas a second active substance is housed in said at least one emergent cavity of the second element.

According to one embodiment, the first active substance is fixedly attached in said at least one emergent cavity of the first element in contact with the electrically conducting porous membrane of the first element.

Likewise, according to one embodiment, the second active substance is fixedly attached in said at least one emergent cavity of the second element in contact with the electrically conducting porous membrane of the second element.

In fact, although it is possible for the active substances, especially when they are in the form of a powder, to be housed freely in their respective cavities, it is particularly advantageous, in particular when the active substances comprise enzymes, for them to be fixedly attached in the emergent cavity so as to contact the electrically conducting porous membrane, for example in the form of a compacted powder disc, since such a construction enables the lifetime of the enzymes to be considerably extended.

Of course, the pore size of the various membranes of the various elements of the module is chosen so as to be smaller than the size of the molecules of the active substance for example, so as to allow the active substances to be trapped in their corresponding cavities.

The module has, according to one embodiment, a size compatible with implantation into the human body.

According to another aspect, there is provided for the use of the module, as defined above, as a biofuel cell when an active fluid, for example a biological liquid, flows at least through the porous membranes and the through-orifices and if applicable through the porous channels provided in at least one of the module elements, so as to interact with the active substance or substances contained in said cavities, a potential difference being generated between the electrically conducting porous membrane of the first module element and the electrically conducting porous membrane of the second module element.

According to another aspect, there is provided a process for manufacturing a module element, comprising the production within a silicon support, of a through-orifice closed off by a porous membrane.

According to one method of implementation, said production comprises: forming, within the support, a porous silicon region having a first face flush with a first face of the support communicating with the outside of the support, depositing metal so as to contact the porous silicon region, forming a silicide of said metal so as to obtain an electrically conducting porous region, and forming, in the support, an emergent cavity bounded by said support and a second face of said electrically conducting porous region, opposite the first face, said electrically conducting porous region forming an electrically conducting porous membrane.

The metal may be deposited on the first face of the porous silicon region, or else directly in the pores of the porous silicon region.

As a variant, the treatment producing said electrically conducting porous membrane may comprise only forming at least one layer of at least one metal on the porous silicon region so as to coat the pores with at least one metal, without it being necessary to carry out a silicidation step. This is the case, for example, when a metal such as gold is used, which does not lead to the formation of a metal silicide.

According to another method of implementation, said production comprises: forming, within the support, a first emergent cavity, forming, in the support, a porous silicon region starting from the bottom wall of said first emergent cavity, and forming, within the support, a second emergent cavity, the two emergent cavities being separated by said porous silicon region forming said porous membrane.

### BRIEF DESCRIPTION OF THE DRAWINGS

Other advantages and features of the invention will become apparent on examining the detailed description of embodiments and methods of implementation which are in no way limiting, and from the appended drawings in which:

FIG. 1 illustrates schematically a first embodiment of a module,

FIG. 2 illustrates schematically an example of the use of the module of FIG. 1 as a biofuel cell,

FIGS. 3 to 10 illustrate schematically an example of the manufacture of a module element,

FIG. 11 illustrates schematically an example of the incorporation of an active substance into a module element,

FIGS. 12 to 15 illustrate schematically other examples of the implementation of a process for manufacturing a module element,

FIGS. 16 and 17 illustrate schematically another embodiment of a module element, and

FIG. 18 illustrates schematically another embodiment of a module.

### DETAILED DESCRIPTION OF THE DRAWINGS

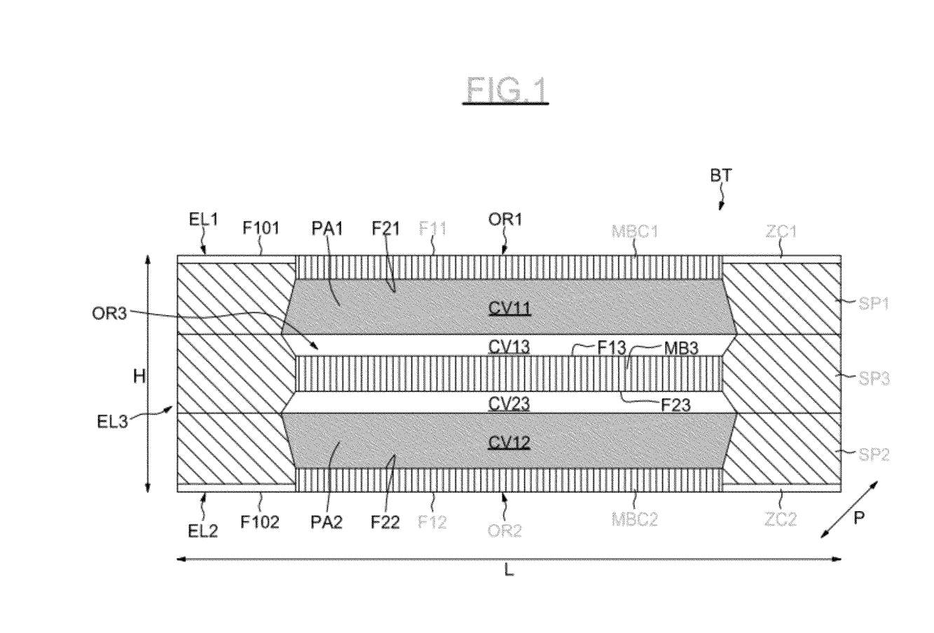

In FIG. 1, the reference BT denotes a module comprising an assembly of three module elements EL1, EL2, EL3.

The module elements are attached to one another, for example, by molecular adhesion, or else using any other means, such as, for example, an adhesive.

The first module element EL1 comprises a support or frame SP1, for example of circular or rectangular shape, comprising, for example at the center thereof, a through-orifice OR1 closed off by a porous membrane MBC1.

This porous membrane MBC1 here is an electrically conducting porous membrane, for example having, at least on the surface, walls of the pores coated with a metal silicide, for example titanium silicide.

The support SP1 also includes, on a first face F101, here its upper face, a contact zone ZC1, for example a zone that also includes a metal silicide. This zone ZC1 is placed here on the periphery of the membrane MBC1 and is in contact with the porous membrane MBC1 so as to be electrically coupled to said membrane.

The first face F11 of the porous membrane MBC1 is flush with the first face F101 of the silicon support SP1, and the second face F21 of the membrane MBC1, opposite the first face F11, forms the bottom wall of a cavity CV11 formed in the support SP1.

This cavity CV11 is consequently bounded by the second face F21 of the porous membrane and laterally by the support SP1. The cavity CV11 opens onto the second face of the support SP1, on the opposite side from the first face F101.

The cavity CV11 forms, with the pores of the porous membrane MBC1, the through-orifice OR1 which consequently is closed off by this porous membrane MBC1.

In the example shown in FIG. 1, an active substance PA1, for example in the form of a disc comprising a compacted powder, is solidly and mechanically fixed in the cavity CV11 in contact with the face F21 of the porous membrane MBC1. This disc of active substance PA1 is for example forcibly inserted into the cavity CV11.

The second module element EL2 has a structure similar to that of the first module element EL1.

More precisely, it comprises a silicon support or frame SP2 having, at the center thereof, a through-orifice OR2 closed off by an electrically conducting porous membrane MBC2, the first face F12 of which, here the lower face, is flush with the lower face F102 of the support SP2.

Here again, an electrically conducting peripheral contact zone ZC2, for example formed from metal silicide, is placed on the face F102 of the support SP2 and is in contact with the electrically conducting porous membrane MBC2.

An emergent cavity CV12 is bounded, on the one hand, by the face F22, on the opposite side from the face F12, of the membrane MBC2 and laterally by the support SP2.

The cavity CV12 and the pores of the electrically conducting porous membrane MBC2 form the through-orifice OR2, which is closed off by the porous membrane MBC2.

In the example illustrated here, a second active substance PA2, also in the form of a compact powder disc, is fixedly attached and forcibly housed in the cavity CV12 so as to come into contact with the electrically conducting porous membrane MBC2.

The electrically conducting porous membranes of the elements EL1, EL2, may comprise only porous silicon, the pores of which are coated with metal, for example with gold, without it being necessary to carry out a subsequent silicidation (metal silicide formation) step.

In addition to these two module elements EL1, EL2, the module BT includes a third module element EL3 sandwiched between the two elements EL1 and EL2.

This third module element also includes a silicon support SP3 having, at the center thereof, a through-orifice OR3 closed off by a porous membrane MB3 formed here from porous silicon. This porous membrane MB3 need not be electrically conducting.

The porous membrane MB23 defines here, with the support SP3, two emergent cavities CV13 and CV23, placed respectively on either side of the porous membrane MB3.

A first face F13, here the upper face, of the membrane MB3 forms the bottom wall of the cavity CV13 and is therefore located facing the first active substance PA1.

The second face F23 of the membrane MB3, here the lower face, forms the bottom wall of the cavity CV23 and is consequently located facing the second active substance PA2.

The through-orifices OR1, OR2 and OR3 are substantially in alignment so as to form an overall through-orifice for the module BT, making it possible, as will be seen in greater detail below, for a fluid to flow through the pores of the various membranes and said through-orifices.

The pore size of the various membranes is chosen so as to be smaller than the particle size of the powder of active substance so as to enable the active substance to be trapped in the cavities CV11 and CV13 on the one hand and in the cavities CV23 and CV12 on the other.

In this exemplary embodiment, the dimensions of the module BT are advantageously chosen so that the module BT can be easily implanted into the human body. As a non-limiting example, the length L of the module BT may be of the order of one centimeter, for example between 5 and 20 millimeters, whereas the height H of the module may be of the order of one millimeter or less, for example between 100 and 750 microns and the depth P (width) of the module may be of the same order of magnitude as the length.

Moreover, the pore size of the various membranes is, in this exemplary embodiment, of the order of a few nanometers, typically two to three nanometers. As will be seen in greater detail below, in one particular biofuel cell application, this pore size is markedly smaller than the size of the molecules of the active substances but larger than the size of the glucose and oxygen molecules. In this configuration, the molecules of the active substances remain trapped, whereas the glucose and oxygen molecules flow freely through the membranes.

Of course, although the module has been shown here with a parallelepipedal shape, it could have any shape, for example cylindrical.

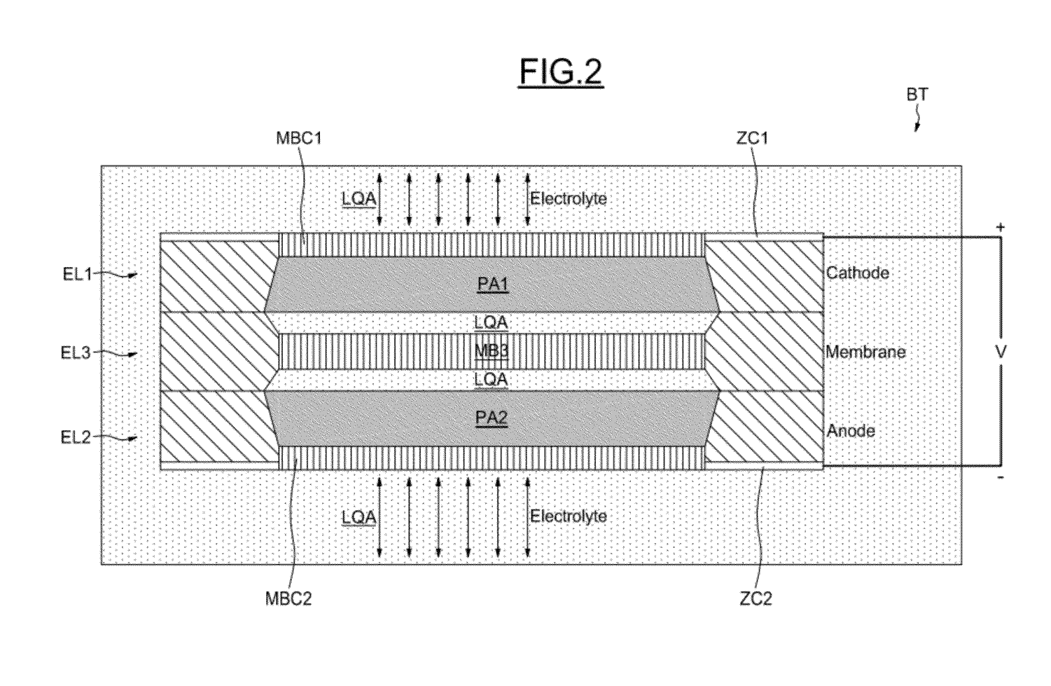

In FIG. 2, the module BT is used as a fuel cell. An active fluid LQA, or electrolyte, may then flow through the various porous membranes and the through-orifices so as to react with the active substances PA1 and PA2 before escaping from the module via the porous membranes MBC1 and MBC2.

Of course, as indicated above, the pore size of the membranes is adjusted so that the active substances PA1 and PA2 do not escape from the cavities in which they are lodged, while being able to react with the active fluid LQA. In one biofuel cell application, the active fluid contains the “fuel” (for example glucose and oxygen).

In other words, the pore size may be larger than two or three nanometers if the molecular size of the active substances so allows. The active substances may contain additives (graphite or carbon nanotube). The size of these additives (for example, carbon nanotubes) is larger than that of the molecules of the active substances and therefore they cannot escape from the cavities.

The use of electrically conducting porous membranes obtained from porous silicon is particularly advantageous since the ratio of electrode surface area to porous silicon volume is very high. Thus, as an example, the electrode surface area (electrically conducting porous membrane) may be up to 1 m² for an initial porous silicon volume of 1 mm³.

The first electrically conducting contact zone ZC1 therefore forms for example the cathode of the fuel cell whereas the second contact zone ZC2, in contact with the membrane MBC2, forms for example the anode of the fuel cell. By dint of the interaction between the active substances PA1, PA2, contacting the electrically conducting membrane MBC1 and MBC2, and the active liquid LQA, an available potential difference V is developed between the contact zones ZC1 and ZC2, and consequently between the two electrically conducting membranes MBC1 and MBC2.

When the module has a size such that it can be implanted into the human body, it may then be used as a biofuel cell. It is then possible to use, by way of example, as active substances PA1 and PA2, and as liquid LQA those described in the aforementioned article by Philippe Cinquin.

Moreover, in this regard the module BT may for example be housed in an appropriate pocket or casing which is itself implanted into the human body, in a manner similar to that described in the aforementioned article by Philippe Cinquin.

In general, a module element may be easily produced employing conventional techniques known per se that are used in microelectronics to fabricate integrated circuits.

Generally, several module elements are produced simultaneously from one and the same silicon wafer. Next, after complete production of the elements, the wafer is diced so as to singulate the elements obtained.

The module elements may for example be produced in 0.35 micron technology on semiconductor wafers 200 mm in diameter or else on wafers 300 mm in diameter in advanced CMOS technology.

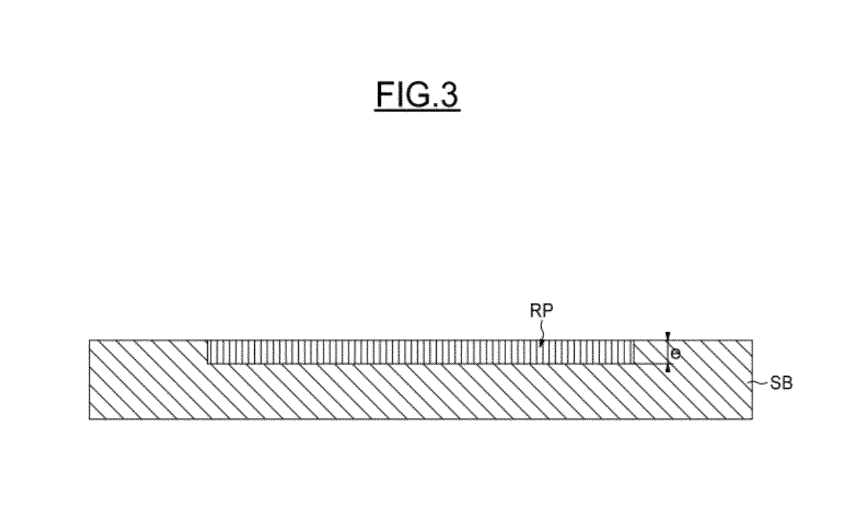

To illustrate an exemplary embodiment of a module element such as that illustrated in FIG. 1, reference will now be more particularly made to FIGS. 3 to 12. For the sake of simplification, the production of only a single module element of the element EL1 or EL2 type of FIG. 1 will be described here.

In a first step illustrated in FIG. 3, a porous silicon region RP is formed in a silicon substrate SB. As is well known to those skilled in the art, the porous silicon is obtained by bulk electrochemical anodization of silicon in a hydrofluoric acid (HF) solution.

Of course, the region of the substrate which is intended not to be converted to porous silicon is protected by a hard mask, for example made of silicon nitride or silicon oxide. These regions may also be protected by converting them to n-type regions by ion implantation of phosphorus, arsenic or any other n-type dopant for silicon.

A person skilled in the art will be able to adjust the electrochemistry parameters and the silicon doping so as to obtain the desired level for the porous silicon region RP and for the desired size of the pores and their shape.

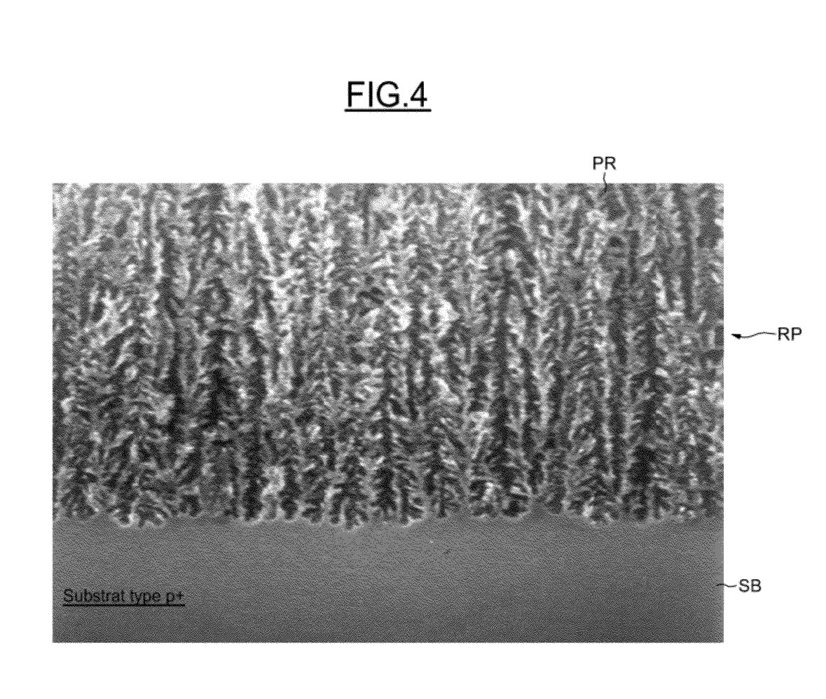

In general, as illustrated in FIG. 4, the pores PR form paths of any shape. The porous region RP of FIG. 4, the pores PR of which have for example a width of the order of 10 nm, was obtained from a silicon substrate p⁺-doped with a doping level of 10¹⁹ cm⁻³ anodized with a current density of 50 mA/cm² in a 25% hydrofluoric acid solution.

It is also possible, by modifying the operating conditions, to obtain a porous region RP, the pores PR of which are more regular and form for example substantially linear parallel columns. Such a pore geometry is more effective for the flow of an electrolyte. A person skilled in the art may for example refer to the article by J. E. A. M. van den Meerakker et al. entitled “Etching of Deep Macropores in 6 in. Si Wafers”, Journal of the Electrochemical Society, 147 (7) 2757-2761 (2000) (the disclosure of which is incorporated by reference).

By way of indication in FIG. 3, the thickness e of the porous silicon region RP is for example around 50 μm.

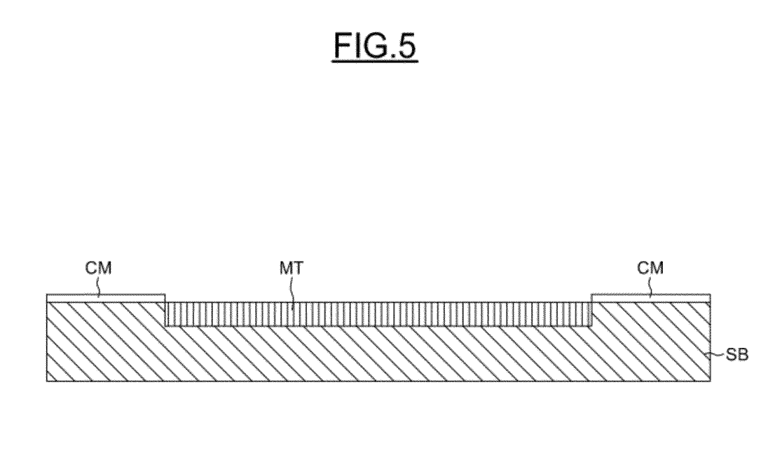

As illustrated in FIG. 5, a metal layer CM is then deposited on the periphery of the region RP, and also on the region RP so that the metal infiltrates the pores of the porous silicon region RP.

The metal may for example be titanium, platinum, nickel or gold.

The metal may be deposited by an autocatalytic (electroless) process employing chemical reactions in the silicon immersed in a liquid bath of said metal which takes place without the use of an external current source.

The metal may also be deposited by ALD (atomic layer deposition).

When the metal deposited so allows, formation of a metal silicide may then be carried out in a conventional manner by heat treatment so as to form the electrically conducting zone ZC and the electrically conducting porous membrane MBC.

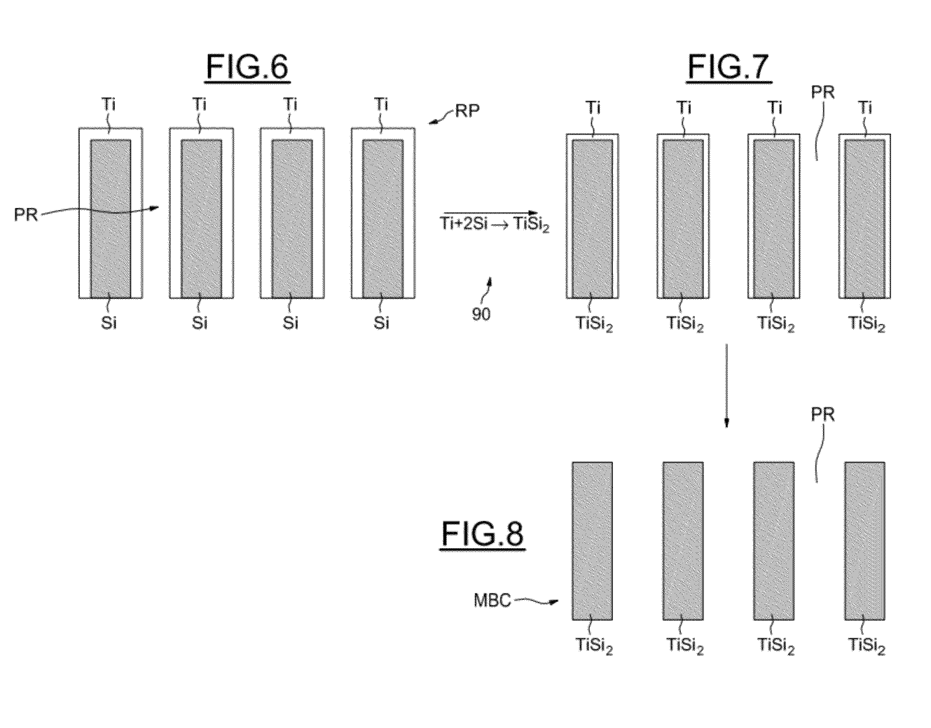

More precisely FIG. 6 illustrates schematically a regular structure of pores PR forming titanium-coated columnar through-paths.

After silicidation 90, the silicon is converted to titanium silicide TiSi₂. It should be noted that after silicidation there is a volume reduction. More precisely, the volume of metal silicide is less than the volume of silicon and metal that has reacted with the silicon. There is thus a 20% volume reduction in the case of titanium and a 15% volume reduction in the case of platinum.

The structure as shown in FIG. 7 is therefore obtained.

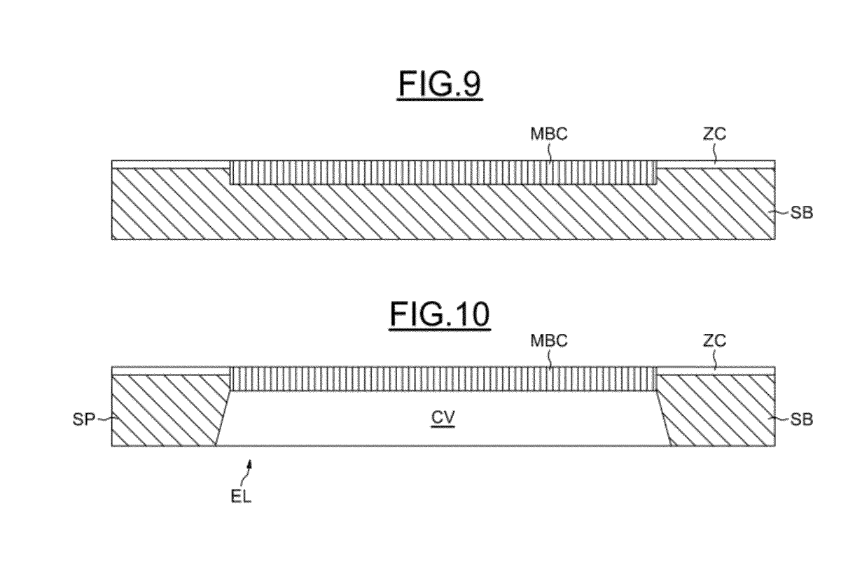

The metal that has not reacted may be removed by appropriate chemistry, for example NH₄OH+H₂O₂+H₂O in the case of titanium so as to form the electrically conducting porous membrane MBC (FIGS. 8 and 9).

Of course, a person skilled in the art will know how to choose the initial pore size of the porous silicon region RP, the amount of metal infiltrated into the pores of this porous region and the silicidation parameters so as to obtain in fine a porous electrically conducting membrane with pores of the desired size (diameter).

Next, as illustrated in FIG. 10, the cavity CV is formed using a conventional etching mask (not shown here). To produce this cavity, a technique identical to that used in microelectronics to form vias passing through a substrate, commonly referred to by those skilled in the art the by acronym TSV (through silicon vias), may be used.

The module element EL is therefore obtained, which may be used as cathode or as anode for the biofuel cell.

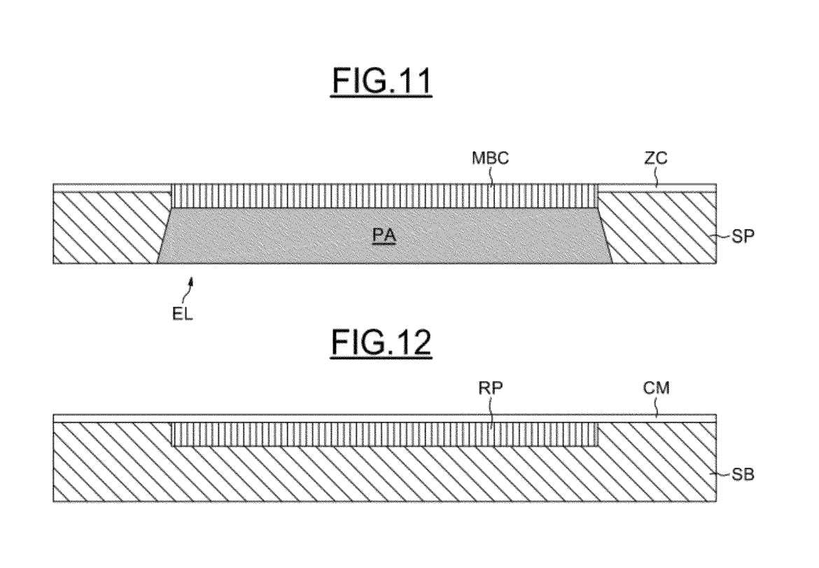

As illustrated in FIG. 11, the cavity CV is filled with the appropriate active substance PA, for example, as indicated above, forcibly with a block of active substance formed from a compact or sintered powder.

As illustrated in FIG. 12, to form the electrically conducting membrane, it would be possible to deposit the metal layer CM over the entirety of the substrate SB and the porous region RP, (for example by PVD deposition) after which the silicidation step is carried out.

In the embodiments that have just been described, the membrane is completely formed from metal silicide.

As a variant, the porous region could be only partially silicided (on the surface) so as to obtain an electrically conducting porous membrane MBC comprising silicon coated with metal silicide.

The manufacture of the membrane element EL3 does not require the porous region to be silicided.

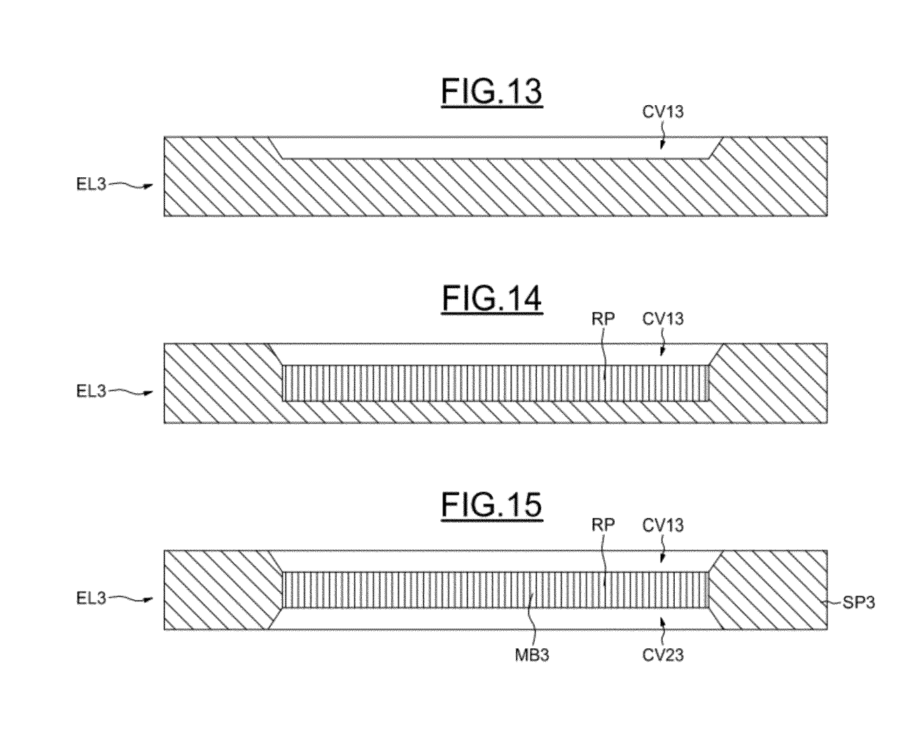

Thus, the process starts by using an etching mask to etch the cavity CV13 of the element EL3 (FIG. 13), again using the technique for fabricating TSVs.

Next, a porous silicon region (RP) is produced (FIG. 14) at the bottom of the cavity CV13. Next, starting from the other side of the silicon support, the cavity CV23 is produced in a similar manner to the production of the cavity CV13 (FIG. 15). The porous region RP then forms the porous membrane MB3.

As a variant, to increase the current output by the fuel cell, the cavities CV13 and CV23 may be filled with active substances PA1 and PA2, respectively.

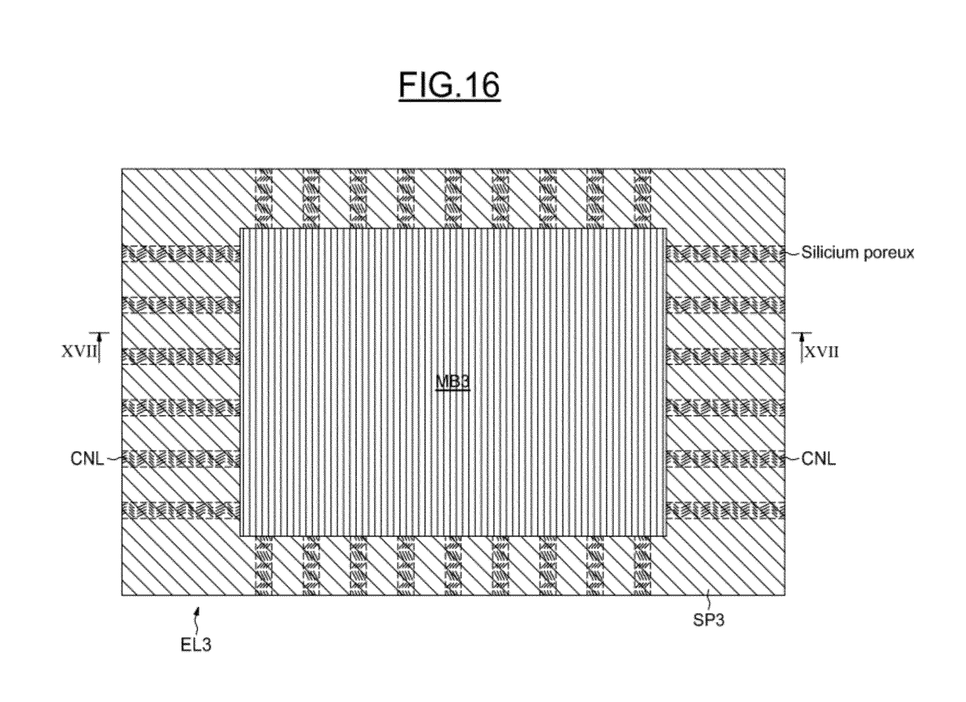

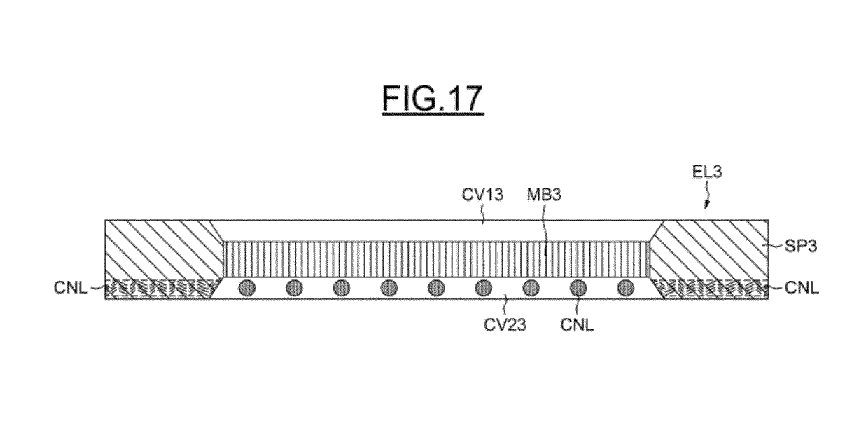

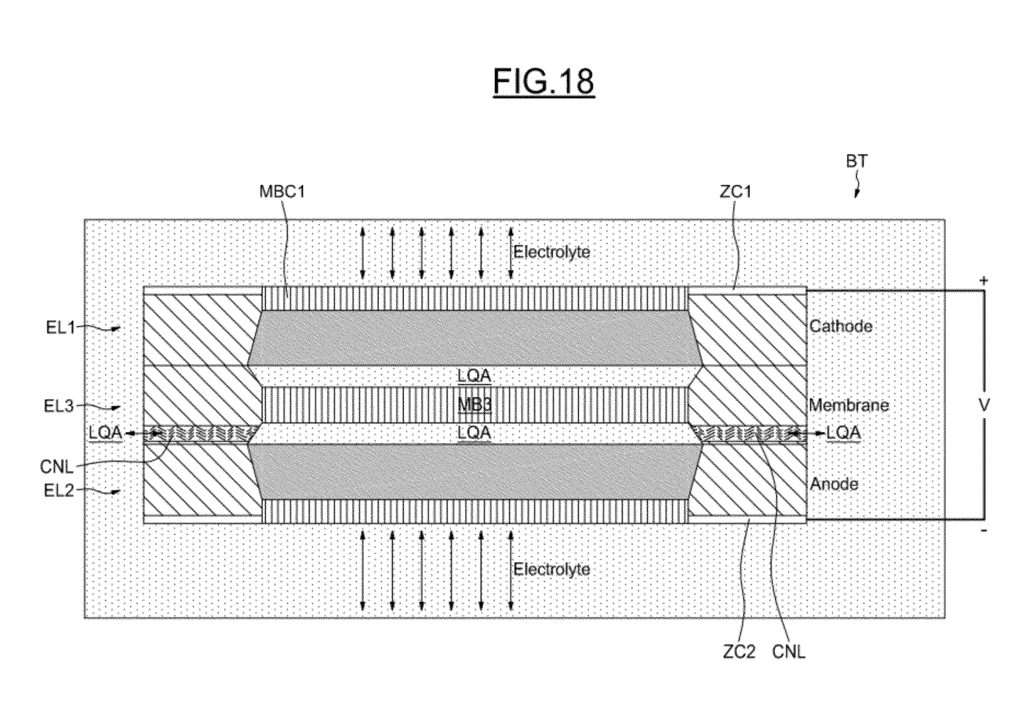

In the embodiment illustrated schematically in FIGS. 16 and 17, the membrane element EL3 comprises several porous silicon through-channels CNL provided in the support SP3 and connecting the emergent cavity CV23 to an external wall of the support.

These porous silicon channels may be formed at the same time as the formation of the region RP of FIG. 14. This makes it possible, for example, as illustrated in FIG. 18, for the active liquid LQA to flow through the channels CNL so as to increase the flux into the anode chamber of the module BT.

This being the case, porous through-channels could also connect the emergent cavity CV13 to an external wall of the support so as to increase the flux into the cathode chamber of the module BT.

What is claimed is:

1. A module element, comprising:
a silicon support having a through-orifice closed off by a porous membrane attached to said silicon support so as to define at least one emergent cavity; and
wherein said silicon support further comprises at least one porous through-channel extending through the silicon support and connecting said at least one emergent cavity to at least one external wall of the silicon support.

2. The module element according to claim 1, wherein a size of the pores of the porous membrane is of the order of 2 to 3 nm.

3. The module element according to claim 1, wherein said porous membrane is electrically conducting.

4. The module element according to claim 3, wherein the silicon support further includes an electrically conducting contact zone electrically coupled to said electrically conducting porous membrane.

5. The module element according to claim 3, wherein said electrically conducting porous membrane comprises a metal silicide.

6. The module element according to claim 3, wherein said electrically conducting porous membrane comprises porous silicon coated with a metal silicide.

7. The module element according to claim 1, wherein the porous membrane comprises porous silicon.

8. The module element according to claim 1, wherein said porous membrane delimits with the support two emergent cavities that are formed in said through-orifice and located respectively on either side of said membrane.

9. A module, comprising:
a first module element having a through-orifice in a first silicon support closed off by a first porous membrane,
a second module element having a through-orifice in a second silicon support closed off by a second porous membrane, and
a third module element placed between the first module element and the second module element, the first, second and third module elements being attached to one another, the third module element having a through-orifice in a third silicon support closed off by a third membrane so as to define at least one emergent cavity,
a first active substance housed in the through-orifice between the first and third module elements, and
a second active substance housed in the through-orifice between the second and third module elements.

10. The module according to claim 9, wherein the first porous membrane is electrically conducting and the first active substance is fixedly attached in contact with the electrically conducting first porous membrane.

11. The module according to claim 9, wherein the second porous membrane is electrically conducting and the second active substance is fixedly attached in contact with the electrically conducting second porous membrane.

12. The module according to claim 9, wherein said module has a size compatible with implantation of the module into the human body.

13. The module according to claim 9, wherein at least one of the first and second active substances comprises a powder having a particle size greater than a pore size of the porous membrane.

14. The module according to claim 9, further comprising electrical connections with the first and second porous membranes defining an anode and cathode of a biofuel cell.

15. The module according to claim 14, wherein the active substances of the module interact with an active fluid flowable through the porous membranes and the through-orifices to produce a potential difference between the anode and cathode.

16. The module according to claim 9, further comprising at least one porous through-channel extending through the third silicon support and connecting said at least one emergent cavity to at least one external wall of the third silicon support

17. A process, comprising:
producing a porous region in a silicon support;
removing a portion of the silicon support adjacent the porous region to define at least one emergent cavity; and
producing at least one porous through-channel extending through the silicon support and connecting said at least one emergent cavity to at least one external wall of the silicon support.

18. The process according to claim 17, wherein producing the porous region comprises:
forming, within the support, a porous silicon region having a first face flush with a first face of the support communicating with the outside of the support,
depositing metal so as to contact the porous silicon region and optionally forming a silicide of said metal so as to obtain an electrically conducting porous region, and
forming, in the support, an emergent cavity bounded by said support and a second face of said electrically conducting porous region, opposite the first face, said electrically conducting porous region forming an electrically conducting porous membrane.

19. The process according to claim 18, wherein metal is deposited on the first face of the porous silicon region.

20. The process according to claim 18, wherein metal is deposited in the pores of the porous silicon region.

21. The process according to claim 17, wherein removing comprises removing from either side of the porous silicon region to produce a first emergent cavity and a second emergent cavity on opposite sides of the porous silicon region.
